(19) United States
(12) Patent Application Publication
(10) Pub. No.: US 2008/0152945 A1
(43) Pub. Date: Jun. 26, 2008

(54) Fiber reinforced gypsum panel

(76) Inventors: David Paul Miller, Lindenhurst, IL (US); Qingxia Liu, Vernon Hills, IL (US); Qiang Yu, Grayslake, IL (US)

Correspondence Address: GREER, BURNS & CRAIN, LTD., 300 SOUTH WACKER DRIVE, SUITE 2500, CHICAGO, IL, 60603, US

(21) Appl. No.: 11/643,572

(22) Filed: Dec. 20, 2006

(51) Int. Cl. B32B 3/18

(52) U.S. Cl. 428/688; 156/42; 428/411.1

(57) ABSTRACT

A gypsum-containing panel and a method of making it are disclosed including at least one facing layer having a first polymer that is reinforced with reinforcing fibers and a gypsum core that has a second polymer in a second polymer matrix interwoven with a gypsum matrix. The first polymer in the facing layer and said second polymer matrix in said gypsum core form a continuous polymer matrix.

### BACKGROUND

This invention relates to a fiber reinforced gypsum panel. More specifically, it relates to a fiber-reinforced gypsum panel that is strengthened by a polymer web throughout the gypsum core.

Fiber reinforced gypsum panels are commonly used in building construction as wall panels, ceiling panels, underlayments, sheathing board, shaft liners, soffit board, backing board and other uses. Part of the strength of gypsum board panels is derived from the facing material that is adhered to the panel core. Many materials are known as facing materials, including paper, fiberglass and plastic sheets. Paper is commonly used as a facing material on interior wallboard, but it is easily damaged and has limited strength. Paper manufacturing also adds an incremental cost to the product due to the capital cost of paper mills as well as the additional process step of paper manufacturing.

Fiberglass facings, including scrims, are tough, strong and can be water resistant, however, they make less than ideal surfaces for interior walls. The surface of fiberglass facing, particularly a woven scrim, is not as smooth as paper for painting, wallpapering and other forms of decorative finishes. Finishing of the surface of gypsum panels is intended to form a smooth, monolithic surface. Such a surface is more difficult to obtain when woven or particulate matter is present on the surface.

Another disadvantage of fiberglass facings is that it is difficult to bond to the gypsum core. Fiberglass is relatively inert and does not chemically bond with the gypsum crystals. The inorganic glass bonds to the gypsum matrix typically through mechanical interlocking or at best hydrogen bonding. Because the adhesion is weak, the fiberglass delaminates from the gypsum core when reasonable force is applied to it.

Further, application of a fiber-reinforced facing does not alter the core of the gypsum panel, which remains somewhat easily damaged. This is a problem where the facing delaminates and becomes separated from the gypsum core, causing failure of the panel system.

The prior art addresses these issues through the use of a polymer component in the surface fiberglass to coat the fiberglass. In particular, due to the unusual handling characteristics, a cellulose ether may be used to pretreat or precoat the fiberglass prior to its application to the gypsum based substrate. The cellulose ether can be applied to a fiberglass scrim or chopped glass to coat and bond to the fibers to decrease skin irritation when the composite is handled or cut. This solution addresses the surface characteristics of the facing. Some improvement in the adhesion of the fiberglass to gypsum in the immediate area around the fiberglass may occur, but it fails to strengthen the gypsum matrix in the core of the board.

### SUMMARY OF THE INVENTION

These and other needs are met or exceeded by a gypsum-containing panel including at least one facing layer having a first polymer that is reinforced with reinforcing fibers and a gypsum core that has a second polymer in a second polymer matrix interwoven with a gypsum matrix. The first polymer in the facing layer and the second polymer matrix in the gypsum core form a continuous polymer matrix.

Another aspect of this invention is a method of making a reinforced gypsum panel that includes combining a water-soluble, film-forming second polymer, water and reinforcing fibers to make a facing material. A dispersion is made of water and the water-soluble, film-forming second polymer. The dispersion is initially maintained above the gel temperature of the second polymer. The dispersion is mixed into a slurry of calcium sulfate hemihydrate and water and the calcium sulfate hemihydrate is hydrated to form a gypsum core comprising a matrix of calcium sulfate dihydrate crystals. The dispersion is cooled below the gel temperature during mixing. As the gypsum matrix forms, it is interwoven with the film formed by gelling of the second polymer. At least one facing made using the first polymer is bonded to the core by forming a continuous polymer matrix through the core and the facing.

The present invention is for an improved gypsum board composition that strengthens both the surface of the board as well as the gypsum matrix in the board core. Application of a facing is known to improve strength of gypsum-containing panels. Bonding of the facing material to the core by cross linking of the first polymer with the second polymer adds to that strength and integrity of the panel system. It also prevents delamination of the facing material since the facing and the core are chemically bonded to each other. Addition of the polymer to both the gypsum core and the facing material leads to formation of a single, continuous polymer phase throughout the facing and the gypsum core. This adds a new dimension of bonding between the gypsum core and the facing that is not achieved with adhesives.

Additionally, coating or embedding of the fiberglass in the first polymer reduces the uneven surface associated with use of chopped fiberglass in the surface coating. Cheaper fiberglass components are also able to be used to achieve similar reinforcing effects on the panel system. This technique also reduces irritation associated with fiberglass handling.

### BRIEF DESCRIPTION OF THE DRAWINGS

FIG. 1 is a scanning electron micrograph of a gypsum core of the second embodiment of the invention;

FIG. 2 is a scanning electron micrograph of the gypsum board of Example 2 at 10,000×;

FIG. 3 is a scanning electron micrograph of FIG. 1 at 15,000×; and

FIG. 4 is a scanning electron micrograph of FIG. 2 at 20,000×.

### DETAILED DESCRIPTION OF THE INVENTION

A particularly strong gypsum panel is obtained by the present invention. Gypsum panels are available in a variety of sizes and shapes, depending on the application with which they will be used. One-half inch (12.5 mm) thick panels are used for light duty use. As the thickness increases, the load bearing and fire-resistance of the panel increases. Panels one inch (25 mm) or more are used routinely where a high degree of fire-resistance is needed, such as in linings of elevator shafts.

The gypsum panel includes at least one facing that includes a first polymer and is reinforced with reinforcing fibers. Any fiber that strengthens the facing is useful. Preferred fibers include polyvinyl alcohol fibers, polyester fibers, polypropylene fibers, glass fibers, wood fibers, carbon fibers, lignocellulosic fibers, nylon fibers or mixtures thereof. Glass fibers are more preferred fibers.

Size of the reinforcing fiber varies with the type of fiber used. The length of the reinforcing fiber should be maximized to create a stronger matrix of materials in the facing. However, as the length of the reinforcing fiber increases, the fibers become increasingly difficult to combine uniformly with the polymer. Reinforcing fiber length should not exceed that which is dispersible in the polymer with the mixing equipment and time that is available. Some preferred embodiments use reinforcing fibers that are about 0.4 to about 0.6 inches in length. Other preferred embodiments utilize glass fibers having a mean length of about ½ inch (1.27 cm).

The preferred diameter of the reinforcing fibers varies similarly with the material from which the fibers are made. Generally, a larger number of thin diameter fibers are preferred. In the case of glass fiber, however, as the diameter decreases, glass fibers cease behaving as individual strands and act as a glass wool. Individual strands are preferred, especially those having a diameter of about 9 to about 16 microns. Wood fibers of up to ½ mm are also useful.

The fibers are embedded in a polymeric matrix of a first polymer which forms a continuous phase, holding the fibers together. The first polymer is a water soluble, film-forming polymer. Preferably, the first polymer is a cellulose ether, including hydroxypropyl methylcellulose and hydroxyethyl methylcellulose. Polyvinyl acetate also makes a very flexible facing layer. A process for making gypsum fiberboard with polyvinyl acetate coating is described in U.S. patent Publication No. 2002/0086173 A1, filed Dec. 29, 2000, published Jul. 4, 2002, now abandoned, herein incorporated by reference. The first polymer is applied at the rate of about 4 to about 20 grams per square foot (about 100 to about 222 grams per square meter) of the panel surface.

To make the facing, the fibers are mixed with the first polymer. Any suitable coating method may be used. Preferred coating methods include blade coating, curtain coating and spraying. Another method of applying the polymer is by electrostatically applying it dry to the fibers, then spraying it with hot water to form a solution. The first polymer forms a film as it cools and dries. In preferred embodiments, the polymer is dispersed in water to get a more uniform coating as the facing dries.

The facing optionally includes ammonium phosphate. This component acts as a cross-linker for the first polymer, enhancing the strength. It also acts as a fire retardant. Optionally, the facing also includes a biocide to inhibit mold growth.

Attached to the at least one facing is a gypsum core. The core includes a second polymer distributed throughout the core and bonded to the first polymer in the facing to form a continuous polymer matrix throughout the entire panel. The term “bonded” is intended to encompass direct bonding of the first polymer to the second polymer by chemical bonding, cross-linking or polymerization, including formation of a block co-polymer of the first polymer and the second polymer. Inclusion of a discontinuity in polymer composition is contemplated at the interface between the core and the facing, as long as the polymer on each side of the discontinuity are chemically linked to each other. In some preferred embodiments, the first polymer and the second polymer are the same polymer. The preferred amount of the second polymer ranged from about 0.3% to about 4% based on the weight of the gypsum present. Bonding of the core to two or more facings is also contemplated.

The core also has a continuous gypsum matrix that is interwoven with the second polymer matrix. When the core is made, the second polymer matrix and the gypsum matrix are formed at the same time, allowing the second polymer to encompass the calcium sulfate dihydrate crystals or allowing the calcium sulfate dihydrate crystals to align themselves in and around the second polymer film as it forms. Each of these matrix structures adds strength to the other by the interweaving of the two diverse networks.

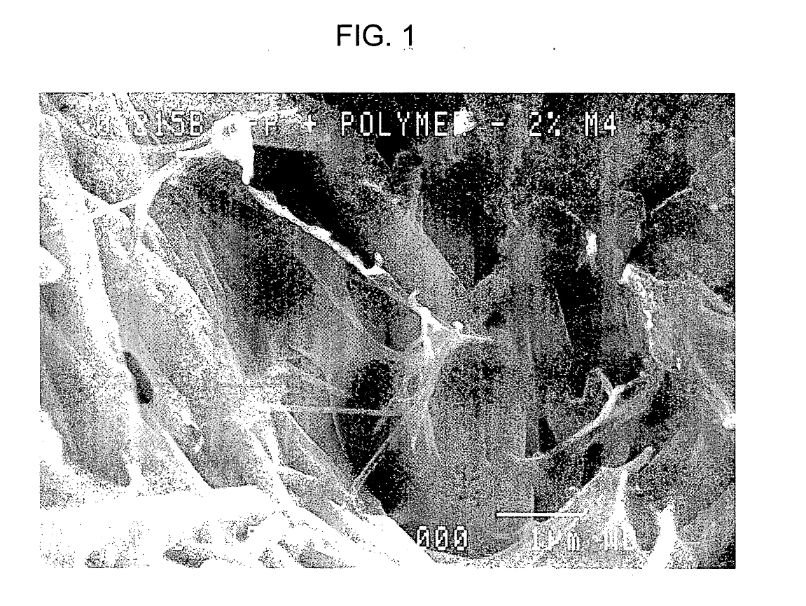

FIG. 1 shows an electron micrograph of the core material of a fiber-reinforced, gypsum material. The gypsum matrix is shown as the long, needle-like structures. Reinforcing fibers are shown in the upper right quadrant of the micrograph as structures having more rounded edges and being noticeably wider than the gypsum structures. The polymer matrix is shown as the film and the very thin strands. Near the center of the micrograph, a hole in the polymer film that clearly shows that the polymer is present as a film that binds several gypsum crystals together.

The second polymer in the core and the first polymer in the facing are selected to bond together at the interface of the facing and the core. Both polymer films form film matrices as the temperature is reduced and water concentrations decrease. For bonding to occur between the two entities, the facing is placed in contact with the gypsum panel core while the polymer matrices are still being formed. At the interface, both of the forming films bond with each other in localized areas where both polymers are present. Bonding of the polymer matrices enhances the adhesion between the facing and the core. Preferably the first and second polymers are the same polymer, but use of different polymers is contemplated.

At least two methods of making the panel of this invention are used in making at least two preferred embodiments. In a first embodiment, the core of the gypsum panel has a large fraction of gypsum combined with conventional additives to modify the board properties. A second embodiment is a fiber reinforced panel made with cellulosic host particles embedded within the gypsum matrix.

In the first embodiment, calcined gypsum is used to make the core layer. Any calcined gypsum comprising calcium sulfate hemihydrate or water-soluble calcium sulfate anhydrite or both is useful. Calcium sulfate hemihydrate exists in at least two crystal forms, the alpha and beta forms. Beta calcium sulfate hemihydrate is commonly used in gypsum board panels, but is also contemplated that layers made of alpha calcium sulfate hemihydrate are useful in this invention. Either or both of these forms is used to create a preferred core layer that is at least 50% gypsum based on the weight of the core layer. Preferably, the amount of gypsum is at least 80%. In some embodiments, the core layer is at least 98% gypsum by weight. Where the water-soluble form of calcium sulfate anhydrite is used, it is preferably used in small amounts of less than 20%.

A slurry for making the core layer is made of water, calcium sulfate hemihydrate, and the first polymer. Water is present in any amount useful to make the layer. Sufficient water is added to the dry components to make a flowable slurry. A suitable amount of water exceeds 75% of the amount needed to hydrate all of the calcined gypsum to form calcium sulfate dihydrate. The exact amount of water is determined, at least in part, by the application with which the product will be used, the type of calcined gypsum used and the amount and type of additives used. Water content is determined, in part, by the type of calcined gypsum that is used. As the aspect ratio of the alpha increases, the entanglement becomes a more significant mechanism than the wetted surface area. Alpha-calcined stucco typically requires less water to achieve the same flowability as beta-calcined stucco. A water-to-stucco ratio is calculated based on the weight of water compared to the weight of the dry calcined gypsum. Preferred ratios range from about 0.5:1 to about 1.5:1. Preferably, the calcined gypsum is primarily a beta hemihydrate in which case the water to calcined gypsum ratio is preferably from about 0.7:1 to about 1.5:1, more preferably, from about 0.7:1 to about 1.4:1, even more preferably, from about 0.75:1 to about 1.2:1, and still more preferably from about 0.77:1 to about 1.1:1.

Water used to make the slurry should be as pure as practical for best control of the properties of both the slurry and the set plaster. Salts and organic compounds are well known to modify the set time of the slurry, varying widely from accelerators to set inhibitors. Some impurities lead to irregularities in the structure as the interlocking matrix of dihydrate crystals forms, reducing the strength of the set product. Product strength and consistency is thus enhanced by the use of water that is as contaminant-free as practical.

A set accelerator is also an optional component of this composition. “CSA” is a gypsum set accelerator comprising 95% calcium sulfate dihydrate co-ground with 5% sugar and heated to 250° F. (121° C.) to caramelize the sugar. CSA is available from United States Gypsum Company, Southard, Okla. plant, and is made according to commonly owned U.S. Pat. No. 3,573,947, herein incorporated by reference. HRA is calcium sulfate dihydrate freshly ground with sugar at a ratio of about 5 to 25 pounds of sugar per 100 pounds of calcium sulfate dihydrate (about 2.27 to 11.36 kg of sugar per 45.5 kg calcium sulfate dihydrate. It is further described in U.S. Pat. No. 2,078,199, herein incorporated by reference. Both of these are preferred accelerators. The use of any gypsum accelerator, or combinations thereof, in appropriate amounts is contemplated for use in this invention.

Another optional component of the core layer is a water reducing agent that enhances the fluidity of the slurry and makes it flowable at lower water addition rates. Polysulfonates, melamine compounds and polycarboxylates are preferred water reducing agents and are included in the slurry in amounts of up to 1.5% based on the dry weight of the ingredients. Where the water reducing agent is added in the form of a liquid, amounts are to be calculated based on the dry solids weight. Preferred water reducing agents are DiloFlo GW (GEO Specialty Chemical, Lafayette, Ind.) and EthaCryl 6-3070 (Lyondell Chemical Co., Houston, Tex.)

One or more enhancing materials are optionally included in the slurry to promote strength, dimensional stability or both. Preferably, the enhancing material is a trimetaphosphate compound, an ammonium polyphosphate having 500-3000 repeating units and a tetrametaphosphate compound, including salts or anionic portions of any of these compounds. Hexametaphosphate compounds are effective for enhancing sag resistance, but are less desirable because they act as set retarders and reduce strength. Enhancing materials are described in commonly owned U.S. Pat. No. 6,342,284. Trimetaphosphate compounds are especially preferred. Sodium trimetaphosphate is commercially available from Solutia Inc. of St. Louis, Mo. The enhancing materials are used in any suitable amount, preferably from about 0.004% to about 2% by weight based on the dry weight of the ingredients.

Foam is optionally added to the slurry as it exits the slurry mixer to promote formation of voids in the set gypsum matrix, thereby improving the acoustic absorption and reducing the overall panel weight. Any conventional foaming agents known to be useful in gypsum products are useful in this application. Preferably, the foaming agent is selected so that it forms a stable foam cell in the core layer. More preferably, at least some of the voids interconnect so as to form an open cell structure. The preferred foam volume is from about 35% to about 60%, more preferably from about 40% to about 55% and even more preferably from about 45% to about 50%. Suitable foaming agents include alkyl ether sulfates and sodium laureth sulfates, such as STEOL® CS-230 (Stepan Chemical, Northfield, Ill.). The foaming agent is added in an amount sufficient to obtain the desired acoustical characteristics in the core layer. Preferably, the foaming agent is present in amounts of about 0.003% to about 0.4% based on the weight of the dry ingredients, and more preferably from about 0.005% to about 0.03%. Optionally, a foam stabilizer is added to the aqueous calcined gypsum slurry in a suitable amount.

Prior to addition to the gypsum slurry, a solution of the second polymer is prepared. To prevent film formation prior to incorporation in the slurry, the solution is kept at a temperature exceeding its gellation temperature until it is added to the slurry. When the second polymer is cellulose ether, it is added to water that has been heated above the gel temperature of 150° F. (65.6° C.). Preferably, the water temperature is from about 170° (76.6° C.) to about 190° F. (87.8° C.). The solution is stored in a jacketed container under constant agitation until it is ready for use. It is pumped through a heated line and mixed with the stucco slurry.

The calcined gypsum and optional dry components are combined with water in the slurry mixer to form the slurry. Preferably, all dry components, such as the calcined gypsum, aggregate, set accelerator, binder and fibers, are blended in a powder mixer prior to addition to the water. Liquid ingredients are added directly to the water before, during or after addition of the dry components. After mixing to obtain a homogeneous slurry, the slurry exits the slurry mixer where the foam is added.

Prior to being added to the slurry, the foaming agent is combined with foam water with the addition of suitable energy to make a foam, which is then added to the slurry at the discharge of the slurry mixer. Once the foam is added to the slurry, it is discharged to a moving conveyor, either directly onto the conveyor surface or onto the optional backing sheet.

In the second embodiment, particle reinforced gypsum articles of the present invention are made by forming a pumpable, flowable gypsum slurry. The primary component of the slurry is a gypsum-containing material. The starting gypsum-containing material includes calcium sulfate dihydrate in any of its forms, including landplaster, terra alba and any non-mined equivalent or mixtures thereof. One preferred gypsum is KCP gypsum, a non-mined gypsum made as a byproduct of power plant flue gas cleaning by Allegheny. Energy Supply (Willow Island, W. Va.). Other suitable gypsum products, including landplaster and terra alba, are available from United States Gypsum Company, Southard, Okla. Wet gypsum can be used in the slurry without first drying it, unlike the conventional paper-faced drywall process. Preferably, the gypsum is of a relatively high purity, and is finely ground. The particle distribution of the gypsum preferably includes at least 92% of the particles at minus 100 mesh or smaller. The gypsum can be introduced as a dry powder or as an aqueous slurry.

The slurry also includes a host particle. A “host particle” is intended to refer to any macroscopic particle, such as a fiber, a chip or a flake, of any substance that is capable of reinforcing gypsum. The particle, which is generally insoluble in the slurry liquid, should also have accessible voids therein; whether pits, cracks, crevices, fissures, hollow cores or other surface imperfections, which are penetrable by the slurry and within which calcium sulfate crystals can form. It is also desirable that such voids are present over an appreciable portion of the particle. The physical bonding between the host particle and the gypsum will be enhanced where the voids are plentiful and well distributed over the particle surface. Preferably, the host particle has a higher tensile and flexural strength than the gypsum. A lignocellulosic fiber, particularly a wood or paper fiber, is an example of a host particle well suited for the slurry and process of this invention. About 0.5 to about 30% by weight of the host particles are used, based on the weight of the gypsum-containing component. More preferably, the finished product includes about 3% to about 20% by weight, more preferably from about 5% to about 15% host particles. Although the discussion that follows is directed to a wood fiber, it is not intended to be limiting, but representative of the broader class of suitable compounds useful here.

Preferably, the wood fiber is in the form of recycled paper, wood pulp, cardboard, wood flakes, other lignocellulosic fiber source or mixtures thereof. Recycled cardboard containers are a particularly preferred source of host particles. The particles may require prior processing to break up clumps, separate oversized and undersized material, and in some cases, pre-extract contaminates that could adversely affect the calcination of the gypsum, such as hemicellulose, flavanoids and the like.

After mixing the slurry of host particles and gypsum, it is heated under pressure to calcine the gypsum, converting it to calcium sulfate alpha hemihydrate. While not wishing to be bound by theory, it is believed that the dilute slurry wets out the host particle, carrying dissolved calcium sulfate into the voids and crevices therein. The hemihydrate eventually nucleates and forms crystals in situ in and on the voids of the host particle. The crystals formed are predominantly acicular crystals which fit into smaller crevices in the host particle and anchor tightly as they form. As a result, calcium sulfate alpha hemihydrate is physically anchored in the voids of the host particles. Crystal modifiers, such as alum, are optionally added to the slurry (General Alum & Chemical Corporation, Holland, Ohio). A process for making gypsum fiberboard with alum is described in U.S. patent Publication No. 2005/0161853, published Jul. 28, 2005, herein incorporated by reference.

Elevated temperatures and pressures are maintained for a sufficient time to convert a large fraction of the calcium sulfate dihydrate to calcium sulfate hemihydrate. Under the conditions listed above, approximately 15 minutes is sufficient time to solubilize the dihydrate form and recrystallize the alpha hemihydrate form. It is desirable to continuously agitate the slurry with gentle stirring or mixing to keep all the particles in suspension and maintain fresh solute around the growing hemihydrate crystals. After the hemihydrate has formed and precipitated out of solution as long, acicular hemihydrate crystals, the pressure on the product slurry is released as the slurry is discharged from the autoclave. The second polymer and any other desired additives are typically added at this time. After formation of the fiber-rich hemihydrate, the slurry is optionally flash dried as the alpha-hemihydrate for later use.

The slurry temperature is used to control the onset of rehydration. At temperatures below 160° F. (71.1° C.), the interlocking matrix of dihydrate crystals reforms, where some of the dihydrate crystals are anchored in the voids of the host particles. This results in a very strong dihydrate crystal matrix into which the host particles have been incorporated. During formation of the dihydrate matrix, the second polymer matrix is also formed. Since both of the matrices are formed from repeating units that are scattered throughout the slurry, an interwoven system of both the dihydrate crystal matrix and the second polymer matrix is formed, with the second polymer matrix forming around the gypsum matrix. The additives are distributed throughout the product article surrounded by the second polymer matrix.

Optional additives are included in the product slurry as desired to modify properties of the finished product as des accelerator, HRA (United States Gypsum Company, Gypsum, Ohio), is ired. Accelerators (up to about 35 lb./MSF (170 g/m2)) are added to modify the rate at which the hydration reactions take place. A preferred set calcium sulfate dihydrate freshly ground with sugar at a ratio of about 5 to 25 pounds of sugar per 100 pounds of calcium sulfate dihydrate. It is further described in U.S. Pat. No. 2,078,199, herein incorporated by reference. Alum is also optionally added to fiberboard for set acceleration. Alum has the added advantage of aiding in the flocculation of small particles during dewatering of the slurry. Additional water-resistance materials, such as wax, are optionally added to the slurry. The additives, which also include preservatives, fire retarders, and strength enhancing components, are added to the slurry when it comes from the autoclave.

In a preferred embodiment, fiberboard is made from the second embodiment of the gypsum slurry. The gypsum-containing component is gypsum and the host particle is paper fiber. Paper slurry is hydrapulped to a 4% suspension and the gypsum is dispersed in water at about 40% solids to form a slurry. These two liquid streams are combined to form a dilute gypsum slurry having about 70% to about 95% by weight water. The gypsum slurry is processed in a pressure vessel at a temperature sufficient to convert the gypsum to calcium sulfate alpha hemihydrate. Steam is injected into the vessel to bring the temperature of the vessel up to between 290° F. (143° C.) and about 315° F. (157° C.), and autogenous pressure. The lower temperature is approximately the practical minimum at which the calcium sulfate dihydrate will calcine to the hemihydrate form within a reasonable time in the presence of the paper. The higher temperature is about the maximum temperature for calcining without undue risk of fiber decomposition. The autoclave temperature is preferably on the order of about 290° F. (143° C.) to about 305° F. (152° C.).

Following calcining, the additives are injected into the gypsum slurry stream. Some additives may be combined with each other prior to addition to the gypsum slurry. Preferably, if water resistance products are desired, the silicone or wax dispersion and the catalyst slurry are separately injected into the gypsum slurry immediately prior to dispensing of the slurry at a headbox. Preferably the additives are dispersed using a large static mixer, similar to that disclosed in U.S. patent Publication No. 2002/0117559, herein incorporated by reference. Passage of the slurry and additives over the irregular interior surfaces of the static mixer cause sufficient turbulence to distribute the additives throughout the slurry.

While still hot, the slurry is pumped into a fourdrinier-style headbox that distributes the slurry across the width of the forming area. The second polymer solution, prepared as described for the first embodiment, is preferably added to the slurry at the headbox. From the headbox, the slurry is deposited onto a continuous drainage fabric where the bulk of the water is removed and on which a filter cake is formed. As much as 90% of the uncombined water may be removed from the filter cake by the felting conveyor. Dewatering is preferably aided by a vacuum to remove additional water. As much water is preferably removed as practical as the hemihydrate cools and is converted to the dihydrate form.

As a consequence of the water removal, the filter cake is cooled to a temperature at which rehydration of the calcium sulfate alpha hemihydrate and gellation of the polymer begin. The calcium sulfate hemihydrate hydrates to the calcium sulfate dihydrate crystal matrix and grows within the remaining polymer solution as the polymer gels. Later drying then forms the polymer film in on and about the calcium sulfate dihydrate crystal matrix and other matrix constituents. It may still be necessary to provide additional external cooling to bring the temperature low enough to effect the rehydration within an acceptable time. The formation of the filter cake and its dewatering are described in U.S. Pat. No. 5,320,677, herein incorporated by reference.

The filter cake, including a plurality of such host particles, is compacted and formed into any desired shape prior to the complete setting or conversion of the calcium sulfate hemihydrate to the dihydrate crystal matrix. Any forming method can be used, including pressing, casting, molding and the like. While the filter cake is still able to be shaped, it is preferably wet-pressed into a board or panel of the desired size, density and thickness. If the board is to be given a special surface texture or a laminated surface finish, the surface is preferably modified during or following this step. A method for manufacturing textured panels and a description of panels made therefrom are described in more detail in U.S. Pat. No. 6,197,235, herein incorporated by reference. During the wet-pressing, which preferably takes place with gradually increasing pressure and increasing water removal to preserve the product integrity, two things happen. Additional water is removed, further cooling the filter cake to drive rehydration. The calcium sulfate hemihydrate crystals are converted to dihydrate crystals in situ in and around the wood fibers.

After rehydration is sufficient that the filter cake holds its shape, it is cut, sent to a kiln for drying of any excess water and trimmed into boards. During the drying step, it is important to raise the temperature of the product high enough to promote evaporation of excess moisture, but low enough that calcination does not occur. It is desirable to dry the product under conditions that limits temperature reached by the product core to about 190° F. (93° C.), more preferably, a core temperature of between about 165° F. (74° C.) and about 190° F. (93° C.) is reached.

### EXAMPLE 1

An example of the fiber-reinforced panel is made using a 5% dispersion based on weight of HPMC in 185° F. (85° C.) water. The dispersion is maintained in a steam jacketed tank to maintain a fluid temperature of 180° F. (82° C.). A weight loss feeder meters the dry HPMC into the tank and a progressing cavity tank meters the HPMC-water dispersion out of the tank. The conical-bottom tank contains a top mounted agitator and center opening bottom outlet and four evenly spaced baffles with the fluid level maintained above the top of the baffles. The HPMC powder is pulled into the vortex formed above the baffles and is carried down into the portion of the tank where the baffles disperse the vortex energy as mixing energy. An insulated and heat traced recirculation line back into the tank tangentially above the baffles helps maintain uniformity. Fluid level is maintained in the tank by a level control device with feedback to an automated valve on a hot water line. Metering of HPMC dispersion out of the system is maintained by a control loop on the positive displacement pump feeding the HPMC to the board mixer through an insulated and heat traced piping and a control loop on the weight loss feeder into the tank.

There are two discharge streams from the HPMC stock tank. A first discharge feeds a curtain coater which is located on a film forming line consisting of a conventional glass chopper drop metering roughly 1 inch (25 mm) fiberglass on a continuous stainless steel band. Immediately following the fiberglass feeder, a conventional curtain coater with insulation and heat tracing to maintain 195° F. (91° C.). is maintained at a gap of around 1 inch (25 mm) from the top of the slurry and discharges a uniform curtain of HPMC onto the surface. The HPMC disperses on and through the chopped glass. As the glass/polymer ribbon proceeds, hot air is used for drying of excess water. When the ribbon gains sufficient integrity, it discharges from the stainless steel belt and is transferred through an air gap to the press section of the board machine. Hot air flow through this air gap then further dries the glass/polymer film.

A second discharge from the HPMC stock tank is added to the calcined gypsum/fiber slurry mixture immediately upstream of a static mixer attached to the headbox inlet manifold. Additional additives such as set accelerators, water resistance additives, and the like are also added at this point. After mixing is achieved with the continuous flow through the static mixer, the resulting slurry is fed through a headbox inlet manifold to a headbox where the slurry is uniformly dispersed across the width of the fourdrinier type forming machine. After initial continuous vacuum dewater followed by continuous roll press vacuum dewatering (commonly known to those skilled in the art), the HPMC/chopped fiberglass film is applied to the continuous mat surface continuously immediately upstream of the secondary or hydrating press. The hydrating press is maintained at a uniform gap as the gypsum sets and expands and the resulting pressure ensures intimate contact of the polymer in the gypsum/paper fiber matrix with the polymer in the polymer/fiberglass film. Exiting the hydrating press, the mat continues to set until fully hydrated before being cut to length prior to continuous drying to remove excess water.

### EXAMPLE 2

The preferred embodiment of the gypsum panel is made using a 5% dispersion by weight of HPMC in 185° F. (85° C.) water. The dispersion is maintained in a steam jacketed tank to maintain a fluid temperature of 180° F. (82° C.). A weight loss feeder meters the dry HPMC into the tank and a progressing cavity tank meters the HPMC-water dispersion out of the tank. The conical-bottom tank contains a top mounted agitator and center opening bottom outlet and four evenly spaced baffles with the fluid level maintained above the top of the baffles. The HPMC powder is pulled into the vortex formed above the baffles and is carried down into the portion of the tank where the baffles disperse the vortex energy as mixing energy. An insulated and heat traced recirculation line back into the tank tangentially above the baffles helps maintain uniformity. Fluid level is maintained in the tank by a level control device with feedback to an automated valve on a hot water line. Metering of HPMC dispersion out of the system is maintained by a control loop on the positive displacement pump feeding the HPMC to the board mixer through an insulated and heat traced piping and a control loop on the weight loss feeder into the tank.

The normal drywall components are added and mixed in the board mixer and the HPMC dispersion is added at the discharge of the mixer immediately upstream of the foam addition. The slurry is then dispersed across the width of the line by a conventional board forming plate over a bottom paper.

To form the top sheet, a conventional glass chopper drops roughly 1 inch (25 mm) fiberglass on the uniform thickness slurry exiting a forming roll, which is used in place of the forming plate to maintain nip cleanliness. A conventional curtain coater with insulation and heat tracing to maintain 195° F. (91° C.) is maintained at a discharge gap of around 1 inch (25 mm) from the top of the slurry and discharges a uniform curtain of HPMC onto the surface. The HPMC disperses on and through the chopped glass onto the surface of the gypsum/foam slurry. This composite uniform structure of HPMC-fiberglass-board slurry then is allowed to hydrate as it moves down a continuous conveyer to a continuous knife where it is cut into manageable panels before being dried in a continuous kiln. Depending on the ambient temperature, cooling is optionally applied by fans above the hydration conveyor prior to the knife.

### EXAMPLE 3

A non-woven glass scrim and ¼″ (6 mm) chopped E glass were used as the fiberglass components. A long chain hydroxyl propyl methyl cellulose ether (“HPMC”) (Culminal by Hercules Chemical Corp., Wilmington, Del.) was used to make a facing material. A 5% dispersion of the HPMC at 180° F. (82.2° C.) was prepared and as the dispersion cooled and started to gel at roughly 150° F. (62.2° C.), was poured over the fiberglass components. The surface of the facing was immediately screeded off with a spatula at each of three heights to yield thin sheets of three different relative concentrations of the polymer on the fiberglass. A thin sheet was formed that quickly cooled and set. After drying, the polymer-glass composite sheet was cut into three inch wide strips and tested in tension with a universal testing machine. Physical testing results of each of the three samples is shown below, with the average load in pounds force as an estimate of the tensile strength of the composite and the average area under the stress/strain curve, TEA as an estimate of the toughness or the relative amount of energy that the sample absorbed before failure.

Samples were made on several substrates, including galvanized steel, stainless steel or plastic release sheet. These are materials commonly used in the composite manufacturing lines and the facing material must be able to release from them. The HPMC released well from all substrates. Data in the following table are averages of six samples each.

TABLE I

| | Dosage, g/ft² | | TEA, lb in/in |
|---|---|---|---|
| Sample | (g/m²) | Load, lbf (N) | (Nm/m) |
| HPMC Mid | 4.3 (0.44) | 64.9 (289) | 1.3 (0.15) |
| HPMC High | 12.0 (1.25) | 95.0 (423) | 2.3 (0.26) |
| HPMC Low | 3.7 (0.38) | 111.3 (495) | 3.2 (0.36) |

Sample toughness was estimated as the area under the tensile stress strain curve to ultimate failure. Samples were analyzed statistically using Minitab software (Minitab, Inc., State College, Pa.). All HPMC additions statistically significantly increased the toughness at a 95% confidence level from that of the glass scrim without HPMC. The best toughness mean value was with the lowest dosage of the HPMC, which had been tightly screeded to remove the most HPMC, but correspondingly had the most pressure to force more of the HPMC into intimate contact with more of the surface area of the fiberglass scrim.

### EXAMPLE 4

A calcined slurry at 200° F. (93° C.) containing 15% solids was mixed with a slurry of 2% HPMC dispersed in 180° F. water. Of the 15% solids, 10% was paper fibers (by weight) and 90% gypsum (by weight). This combined slurry was then uniformly distributed across the 26″ width of a fourdrinier type forming machine (similar to those used for paper, wet process wood fiber insulation board, wet process hardboard, etc.) and then dewatered by first vacuum and then a combination of vacuum and roll pressing. The resulting mat then was held at a constant gap by a secondary press for a substantial part of the gypsum setting process. The resulting panels were cut to length and the excess water dried from them in a forced air dryer at 150° F. (65° C.) overnight. The resulting dry samples were broken and the micrographs taken of the fracture interfaces using a scanning electron microscope.

The attached micrographs show the film attachment to the paper fibers in the gypsum fiberboard matrix as well as the gypsum crystals. Since the paper facing of a drywall product is made out of the same type of paper fibers, the same bonding will occur between the gypsum matrix and the paper fibers in the paper facing of the drywall as it does between the gypsum matrix and the paper fibers in the gypsum fiberboard.

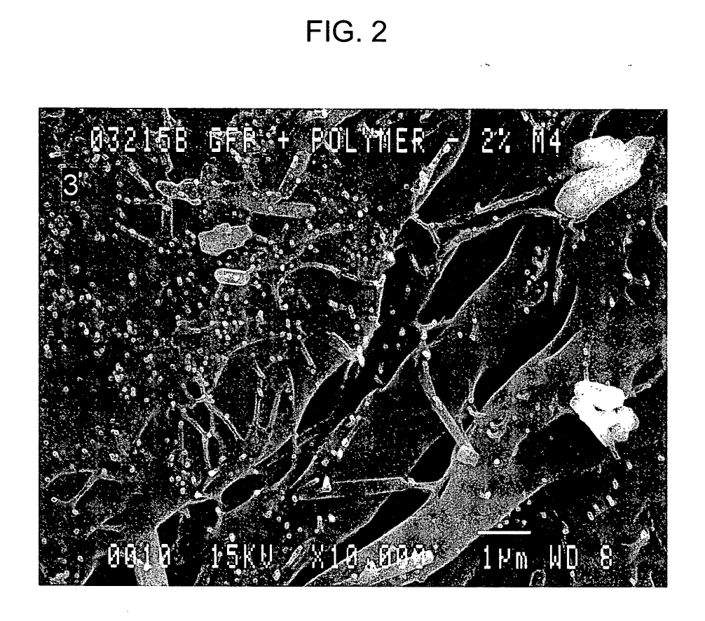

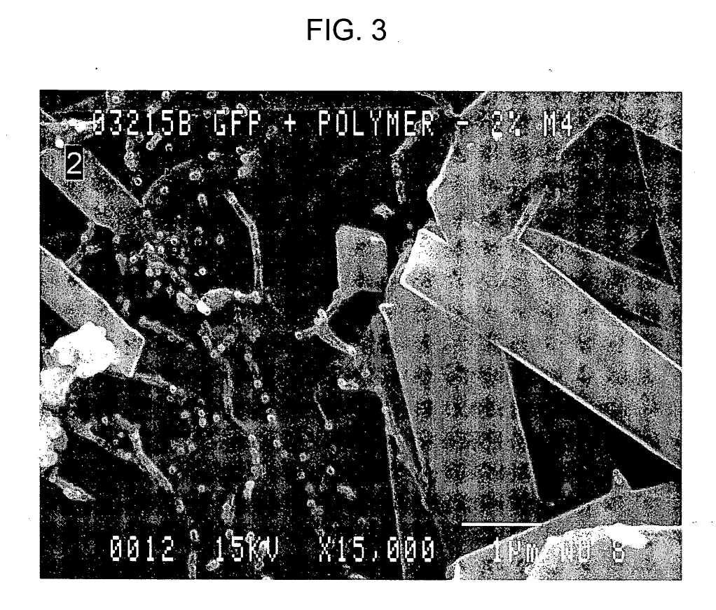

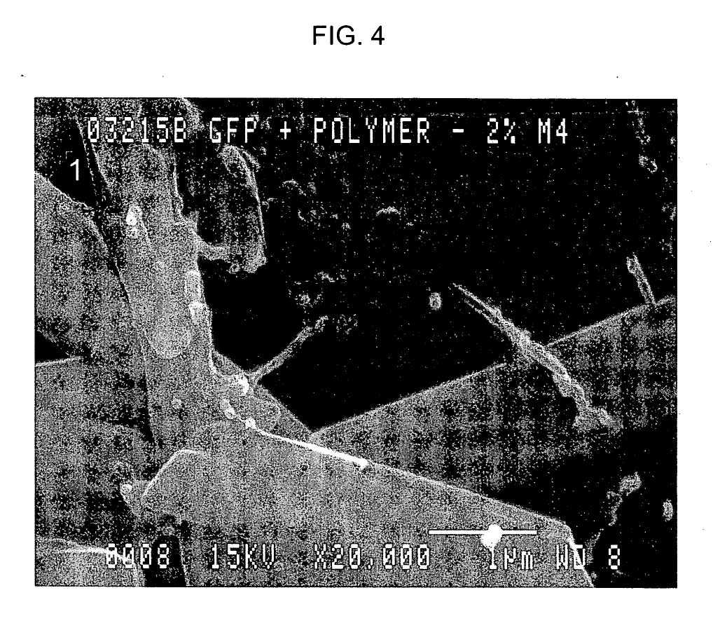

Following are photomicrographs showing the polymer linking the paper fibers in the gypsum fiberboard matrix. FIGS. 2-4 are photomicrographs of the same sample at different magnifications to show the structure. FIG. 2 is a photomicrograph at 10,000×. There are only a few sparse gypsum crystals in the field of view of this micrograph, but the uniform network of the filamentous structures of the dried polymer is clearly evident linking the larger structures. In the micrographs of FIGS. 3 and 4, the crystals are the gypsum crystals and the amorphous-appearing material is actually a portion of a paper fiber. Because of the high magnification, you can only see part of the surface of a paper fiber. Connections of the polymer linkages from gypsum crystal to gypsum crystal and from gypsum crystal to paper fiber are demonstrated.

While a particular embodiment of the polymer for a reinforced gypsum panel has been shown and described, it will be appreciated by those skilled in the art that changes and modifications may be made thereto without departing from the invention in its broader aspects and as set forth in the following claims.

What is claimed is:

1. A gypsum-containing panel comprising:
at least one facing comprising a first polymer that is reinforced with reinforcing fibers; and
a gypsum core comprising a second polymer in a polymer matrix interwoven with a gypsum matrix;
wherein said first polymer in said at least one surface layer and said second polymer matrix in said gypsum core form a continuous polymer matrix.

2. The panel of claim 1 wherein said second polymer is a cellulose ether.

3. The panel of claim 1 wherein said first polymer is the same polymer as said second polymer.

4. The panel of claim 1 wherein said gypsum core comprises from about 0.3 wt % to about 4 wt % of the second polymer based on the weight of said gypsum matrix.

5. The panel of claim 1 wherein said reinforcing fiber is at least one of the group consisting of polyvinyl alcohol fibers, polyester fibers, polypropylene fibers, glass fibers or mixtures thereof.

6. The panel of claim 1 wherein said at least one facing layer comprises two facing layers.

7. The panel of claim 1 wherein said gypsum matrix further comprises host particles having calcium sulfate dihydrate crystals formed in the crevices of said host particle.

8. The panel of claim 7 wherein said host fibers comprise wood fibers.

9. The panel of claim 1 further comprising a second facing comprising paper.

10. A gypsum-containing panel core comprising:
a film-forming polymer in a polymer matrix; and
a matrix of calcium sulfate dihydrate crystals and host particles having calcium sulfate dihydrate crystals formed in the crevices of said host particle and interwoven with a gypsum matrix;
wherein the film-forming polymer matrix and the calcium sulfate dihydrate matrix are interwoven with each other.

11. The core of claim 10 wherein said host fibers comprise wood fibers.

12. The core of claim 10 wherein said core comprises said polymer matrix in amounts of from about 0.3% to about 4% by weight based on the weight of calcium sulfate dihydrate present.

13. A method of making a reinforced gypsum panel comprising:
combining a water-soluble, film-forming first polymer, water and reinforcing fibers to make a facing material;
making a solution of water and a water-soluble, film-forming second polymer;
maintaining the solution above the gel temperature of the first polymer;
mixing the solution into a slurry of calcium sulfate hemihydrate and water;
hydrating the calcium sulfate hemihydrate to form a gypsum core comprising a matrix of calcium sulfate dihydrate crystals interwoven with a film formed by gelling the second polymer;
applying the facing to the core; and
forming a continuous polymer matrix through the core and the facing.

14. The method of claim 13 further comprising dewatering said slurry subsequent to said mixing step.

15. The method of claim 13 wherein said mixing step further comprises adding a host particle.

16. The method of claim 15 further comprising selecting a host particle from the group consisting of paper fibers, wood fibers and mixtures thereof prior to said mixing step.

17. The method of claim 13 wherein said combining step further comprises applying the second polymer to the reinforcing fibers.

18. The method of claim 17 wherein said applying step is selected from the group consisting of spraying the second polymer onto the reinforcing fiber, mixing the reinforcing fiber into the second polymer, coating the reinforcing fiber with the first polymer, electrostatically cover dry polymer on the reinforcing fiber followed by spraying with water, and combinations thereof.
